(19) United States
(12) Patent Application Publication
(10) Pub. No.: US 2025/0263099 A1
(43) Pub. Date: Aug. 21, 2025

(54) CONFIGURABLE AND CUSTOMIZABLE CART

(71) Applicant: TechMaster Carts, LLC, Mounds View, MN (US)

(72) Inventors: Timothy Koes, Blaine, MN (US); Yudah Amit, Eden Prairie, MN (US)

(21) Appl. No.: 18/444,163

(22) Filed: Feb. 16, 2024

(51) Int. Cl. B62B 3/00; B25H 3/02; B62B 3/02; B62B 3/14

(52) U.S. Cl. CPC B62B 3/005; B25H 3/027; B62B 3/02; B62B 3/1468

(57) ABSTRACT

A cart assembly suited for use in a variety of settings including a biomedical environment that includes a rear-located cord locker for organizing and hiding excess lengths of cords need to provide power to power strips on the cart and electronics that are placed on the cart. Also included are customizable panels easily placed on the sides and back of the cart, as well as on the drawer fronts, which are printable using sublimation printing such that the cart may include custom colors, signs, or labels.

### BACKGROUND OF THE INVENTION

Rolling carts are widely used in many industries to store and provide easy access to various supplies, tools, equipment, and other items. These rolling carts may be found in medical facilities, manufacturing facilities, repair shops, hobby shops, retail stores, as well as innumerable other settings. Medical facilities provide one example where a clean, efficient and effectively designed cart is especially important. Due to the delicate nature of medical procedures and the environmental standards of medical facilities, any cart used to assist in medical care must be well built, operate smoothly, and meet strict sterilization requirements. Further, medical carts are typically designed to be multifunctional, and often carry mechanisms to facilitate a number of electronics, cords, lights, instruments, and supplies, all capable of use in sterile environments. As an example, a medical procedure room, such as an operating room requires the existence of a cart that is easily rolled into position, is easily sterilized, and provides numerous conveniences such as adjustability, usable surface area, organization, and easy access to stored contents.

### SUMMARY

Described below are various embodiments of a rolling cart that addresses the aforementioned needs. Generally, the cart will have a plurality of drawers, a back cabinet door that opens to expose a cable locker, folding side tables that may interlock with similar folding side tables of adjacent carts, and multiple surfaces suitable to receive sublimation printing. The cart is particularly well suited to medical applications, but the design is equally suitable for other uses.

In at least one embodiment, various laminate panels are used, with each having surfaces which are suitable for sublimation printing. These laminate panels are easily applied to one or more of the outside surfaces of the cart. the outside surfaces of the cart and surfaces of various cart components are configured to be substrates for the printable panels, including any or all of the vertical surfaces including the drawer fronts. The laminate panels can be constructed of any material, such as aluminum, which accepts sublimation printing. These panels may be attached to the substrate surfaces using double sided tape, hook and loop fasteners, adhesives or mechanical attachment structures (as an example, this may include upper and lower slots sized to allow the panels to be slid into place). Alternatively, the panels may be attached magnetically to the substrate surfaces. The use of panels capable of supporting high resolution graphics and images (via sublimation printing or similar printing techniques) provides an ability generate carts that are visually appealing and customizable. The versatility of these printable panels can also allow the cart to be repurposed by swapping panels to convey different information, such as logos, customized images, drawer contents, use status, warnings, colors, advertisements, and the like. It is also contemplated that the drawer panels present an opportunity to create one or more larger graphic designs that occupy multiple drawers.

In one embodiment, the cart may include a cable locker positioned at the rear of the cart which can contain organizing features such as hooks, loops, belts, magnets, posts, pegs, etc., to name a few non-limiting examples. Other examples of components that may be housed within cable locker include components to facilitate data communication, such as switches, routers, network ports, etc. Further, the cable locker will typically include a door to enclose the contents thereof.

In another embodiment, the cart assembly includes a mounting bracket for computer equipment, such as a keyboard, monitor or display. This bracket could further provide support for a laptop computer or a tablet, thus providing a user with access to computing systems.

In at least one additional embodiment, the cart is an assembly comprising: a top, a front, a left side, a right side, and a back. The top may include a top panel that defines a flat work surface. The top panel may further include features such as one or more recessed trays and a power strip. The top may further support a pole attached thereto, which is extending upwardly from the top panel and constructed to provide an attachment point for accessories, such as monitor swing arms, laptop mounts, IV bag hangers, and the like.

At least one further embodiment of the cart also provides a plurality of drawers that may be opened from the front. The drawers may include known features such as laser-cut foam for tool organization, padded floors to prevent unwanted noise and shifting, and soft closing drawer slides.

In another aspect, a left side and a right side of the cart may include easy access baskets and a folding table extension. The folding table extension may include a distal edge that is configured to mate with a table extension of an adjacent cart to extend the working space significantly. The folding table extension may be constructed and arranged for easily changing the side of the cart to which it is mounted.

At least one of the left side and the right side also includes one or more handles that, in conjunction with large independent casters, allow for ease of maneuverability of the cart. The casters are further constructed from precision materials to accommodate smooth and quite movement of the cart.

Again, a cord locker may be included as part of the cart, which provides an internal space for storing cords and is accessible from a door in the back. The cord locker may include one or a plurality of hooks, loops, or similar cable managers. The cord locker may further include one or more power strips, preferably with a long cord on at least one of the power strips, so that the cart may be able to be powered from a wide variety of locations in a space, without requiring undesired placement in order to reach an outlet. When close to an outlet, the extra length of cord is looped around the cable manager. An access port or hole in the top surface of the cart allows electronics associated with the cart to be easily powered without excess cord exposure. The extra lengths of cord may also be looped around one or more of the cable managers. In one aspect, the wherein the at least one power strip may be plugged into an outlet outside of the cart assembly while the door is closed and excess cord from the at least one power strip may be looped around the at least one cable manager.

### BRIEF DESCRIPTION OF THE DRAWINGS

These and other aspects, features and advantages will be apparent and elucidated from the following description with reference being made to the accompanying drawings, in which:

FIG. 1 is a front-right perspective view of an embodiment of a cart assembly according to the invention;

FIG. 2 is a rear-left perspective view of an embodiment of a cart assembly according to the invention;

FIG. 3 is a top plan view of an embodiment of a cart assembly according to the invention;

FIG. 4 is front elevation of an embodiment of a cart assembly according to the invention;

FIG. 5 is a right elevation of an embodiment of a cart assembly according to the invention;

FIG. 6 is a top plan view of an embodiment of a cart assembly according to the invention;

FIG. 7 is a rear elevation of an embodiment of a cart assembly according to the invention;

FIG. 8 is a left elevation of an embodiment of a cart assembly according to the invention;

FIG. 9 is a perspective view of an embodiment of a cable manager according to the invention;

FIG. 10 is a front elevation of an embodiment of a cable manager according to the invention;

FIG. 11 is a top plan view of an embodiment of a cable manager according to the invention;

FIG. 12 is a side elevation of an embodiment of a cable manager according to the invention;

FIG. 13 is a front elevation of an embodiment of an embodiment of a cart according to the invention;

FIG. 14 is a sectional view taken along section lines 14-14 of FIG. 13;

FIG. 15 is a sectional view taken along section lines 15-15 of FIG. 13;

FIG. 16 is a plan view of an embodiment of a floor panel according to the invention;

FIG. 17 is a perspective view of an embodiment of a side panel according to the invention;

FIG. 18 is a top view of an embodiment of a side panel according to the invention;

FIG. 19 is a perspective view of an embodiment of an interior wall according to the invention;

FIG. 20 is a detailed to view of a tongue feature of an embodiment of an interior wall according to the invention;

FIG. 21 is a front elevation of three carts connected together according to the invention;

FIG. 22 is a bottom view of an embodiment of a folding table extension of one cart adjacent an integrated handle of another cart in preparation for connecting the two carts together according to the invention;

FIG. 23 is a bottom view of the folding table extension and integrated handle of the two carts of FIG. 22 connected together according to the invention;

FIG. 24 is a front elevation of two carts connected together according to the invention;

FIG. 25 is a bottom view of an embodiment of a folding table extension adjacent an embodiment of a second folding table extension with an embodiment of an alignment bar juxtaposed between the two in preparation for connecting the two carts according to the invention;

FIG. 26 is a bottom view of the components shown in FIG. 25 connected together according to the invention;

FIG. 27 is a perspective view of an embodiment of a cart assembly with various mounts attached to a pole being held by a pole support according to the invention;

FIG. 28 is a bottom view of an embodiment of a connecting corner table according to the invention; and,

FIG. 29 is a bottom view of the connecting corner table of FIG. 28 being used to connect folding table extensions of two carts in a right-angled configuration according to the invention.

### DESCRIPTION

Various embodiments will now be described with reference to the accompanying drawings. Many different embodiments could be created, and the present description should not be construed as limited to the embodiments set forth herein; rather, these embodiments are provided so that this disclosure will fully convey the scope of the inventive concepts to those skilled in the art. The terminology used in the description of the embodiments illustrated in the accompanying drawings is not intended to be limiting and like numbers in the drawings refer to like elements.

Turning now to the figures, which show various general views and details of an embodiment of a cart assembly 10. As illustrated, cart assembly 10 generally includes a top 12, a front 14, a left side 16, a right side 18, and a back 20. The cart assembly 10, though described as ideally suited for medical uses and sometimes referred to as a biomedical cart, is extremely versatile and provides an excellent solution to the cart needs of any industry.

The top 12 includes a top panel 30 that may optionally include a flat work surface 32, one or more recessed trays 34 of any shape or configuration for various purposes such as separating or controlling the unintentional migration of small objects. The top panel 30 is also shown as including one or more integrated handles 36. For ease of manufacturing and cleaning, in at least one embodiment the top panel 30 is of unibody construction using a contamination-resistant material such as a polymer or acrylic. In a hospital environment, it is beneficial to make the top panel 30 from a medical-grade, high-density polyethylene. The top panel 30 may further include a power cord access hole 38.

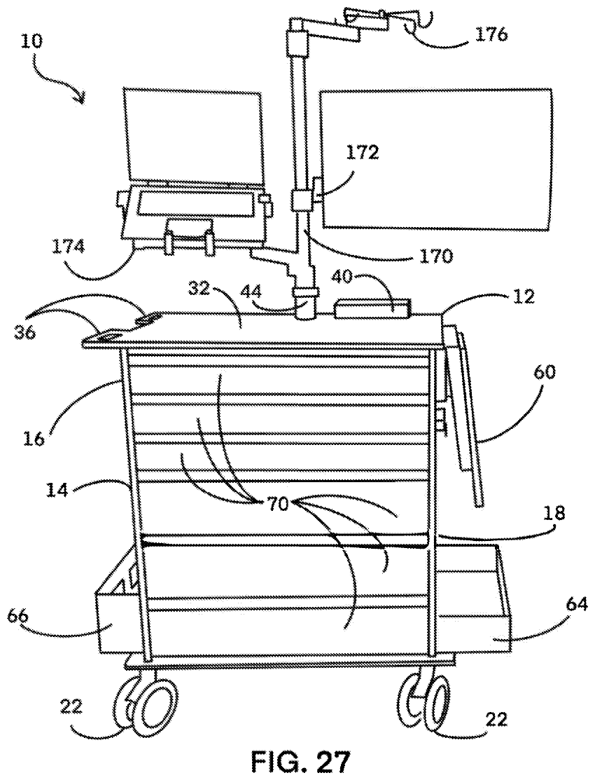

The top 12 may further accommodate accessories such as a power strip 40 and a pole support 44. In the embodiment shown in the Figures, the pole support 44 is affixed to the top panel 30 and comprises a tube extending vertically and sized to receive a pole 170 (see FIG. 27) to which other accessories may be attached. Non-limiting examples of these accessories may include articulating display mounts 172, laptop mounts 174, keyboard supports (not shown), intravenous (IV) bag holder 176, cord holders 42, drug delivery systems (not shown), etc.

One example of an accessory, shown in FIGS. is a cord holder 42 which may take on a variety of forms capable of holding and/or organizing cords. The cord holder 42 shown in the figures includes a lateral extension 50 and a vertical post 52 rising upward from the lateral extension 50 at an end opposite the pole support 44. The cord holder 42 provides a place to hang extra lengths of cords that are plugged into the power strip 40. The power strip 40 may be alternatively, or additionally, be located in a variety of locations, including but not limited to, the left side 16, the right side 18 or the back.

The front 14 of the cart assembly 10 features a plurality of drawers 70. The drawers 70 may be of different heights and are shown as increasing in height towards the bottom of the cart assembly 10. The drawers are of a high-quality construction and use sturdy, quiet soft-close drawer slides, as are known in the art, to facility quiet and smooth operation. In at least one embodiment, a lock 74 is provided to secure the contents of the drawers 70. The lock 74 in the cart embodiment shown in the figures is a smart programmable card access lock located beneath a folding table extension 60, located on either the left side 16 or the right side 18. This allows access to be given or removed easily by simply reprogramming an employee's access card, without having to alter the cart or manage physical keys. Naturally, several alternative locking mechanisms could be incorporated into cart assembly 10, such as mechanical locking systems.

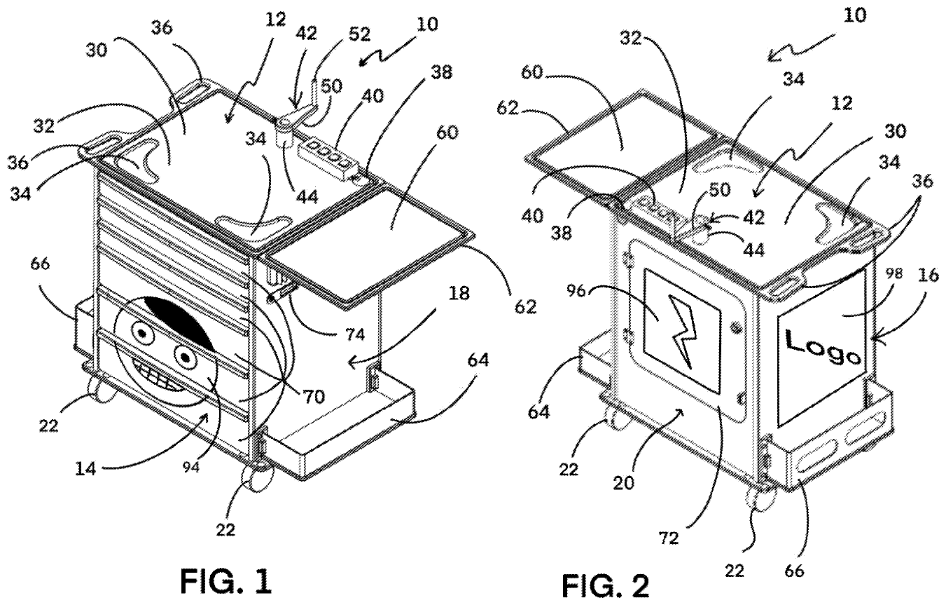

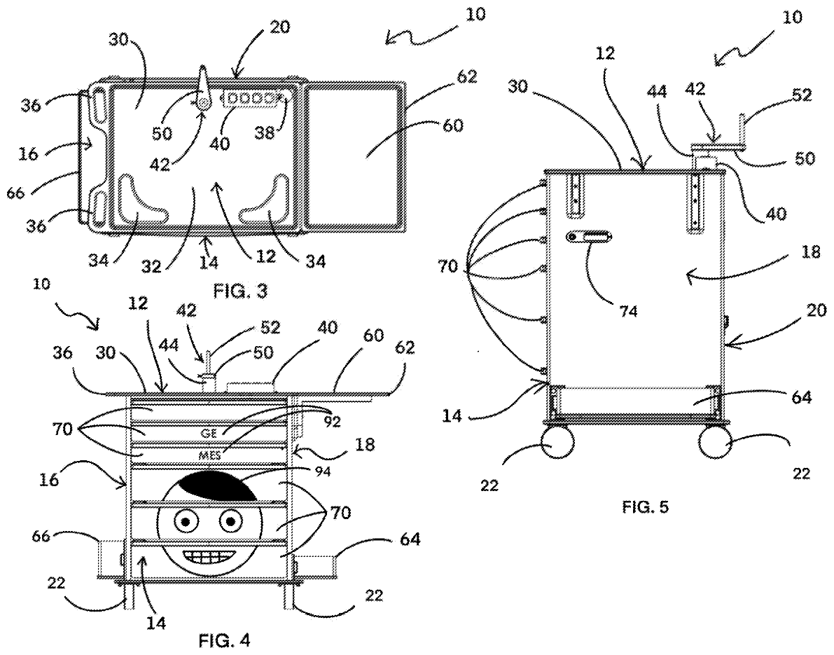

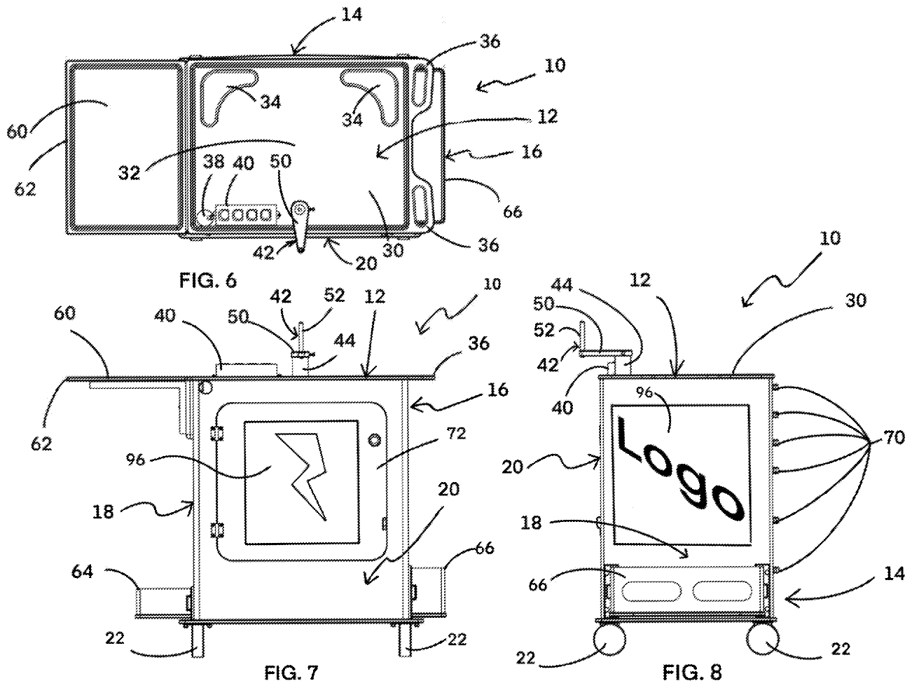

The right side 18 of the cart assembly 10 is shown best in FIGS. 1 and 5, which also illustrates a folding table extension 60. The folding table extension 60 may alternatively be located on the left side 16 or on both sides. The folding table extension 60 increases the size of the working surface of the cart assembly 10 when in the extended position. When not in use, the folding table extension 60 may be folded down so that it rests parallel to the right side 18 surface. A hinge catch mechanism (not shown) is used to hold folding table extension 60 in place, and may be a known mechanism familiar to those skilled in the art.

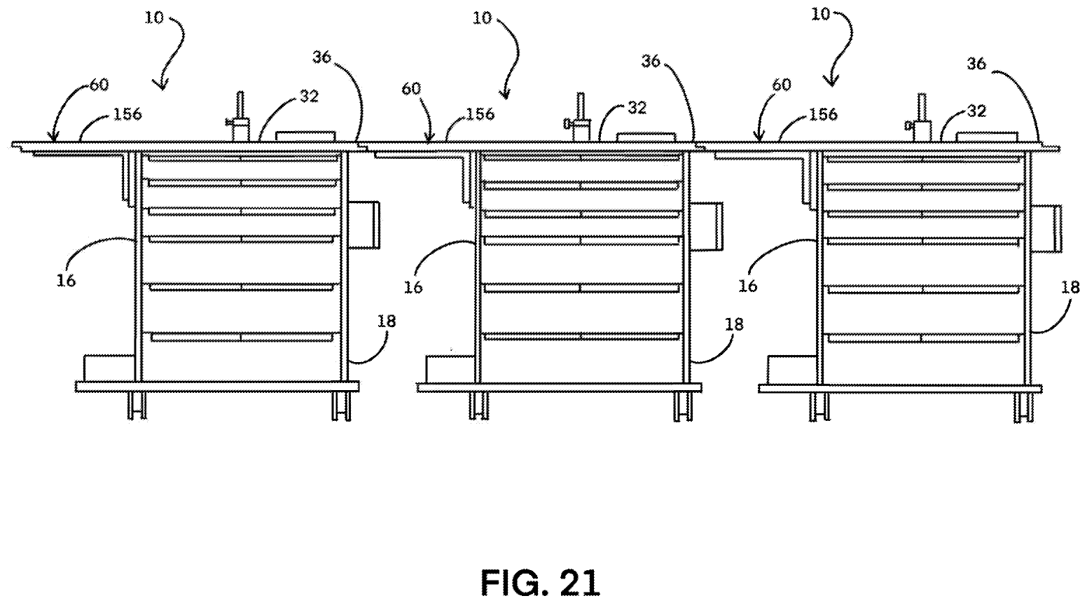

In at least one embodiment, the cart assembly 10 is customizable such that the folding table extension 60 may be located on either side and further, and is shaped, configured, or designed to include an interlocking feature that allows a distal end 62 of the folding table extension 60 to interlock, connect, or otherwise mate with a distal edge of an adjacent cart assembly 10. If it were desired to have the front 14 of both cart assemblies to be facing the same direction, one cart assembly 10 would have the folding table extension 60 on the left side 16 and the other would have the folding table extension 60 on the right side 18. The interlocking feature provided by the distal end 62 may take on various forms depending on the needs of the user. For example, if the environment in which the carts 10 are being used is one in which the carts 10 are unlikely to encounter heavy jostling or similar contact, and/or a quick and smooth transition between adjacent surfaces is important, the distal ends 62 of adjacent carts may include magnetic connectors. Alternatively, if the carts are going to be pulled as a single unit, a mechanical connector, such as latches, or other interlocking features may be used. An exemplary embodiment of an interlocking feature is shown in FIGS. 21-25 and described in more detail below.

The right side 18 is also shown as optionally including a right basket 64 that may be convenient for storing taller items such as liquid bottles, cleaning supplies, etc. Similarly, a left basket 66 is optionally provided on the left side 16.

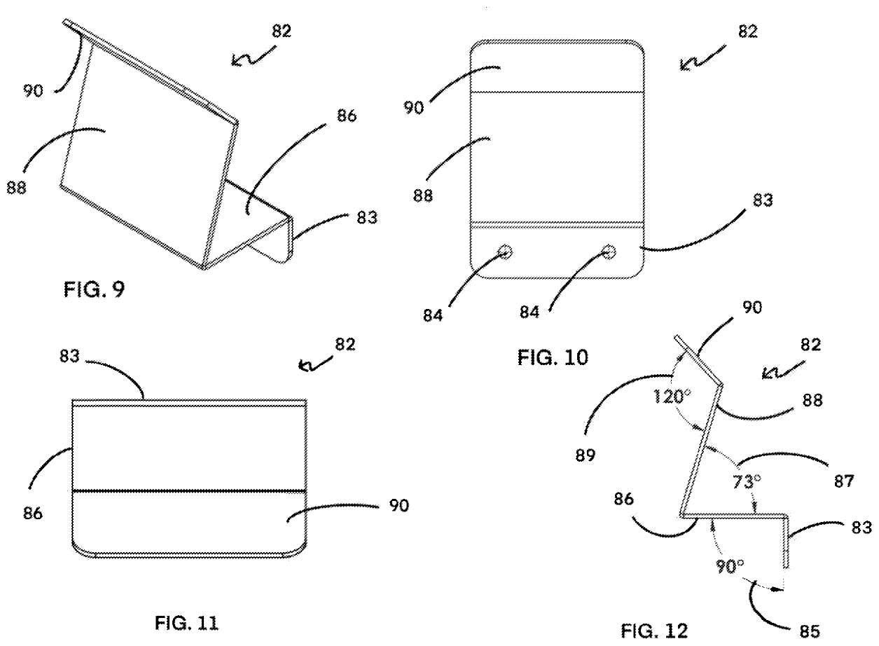

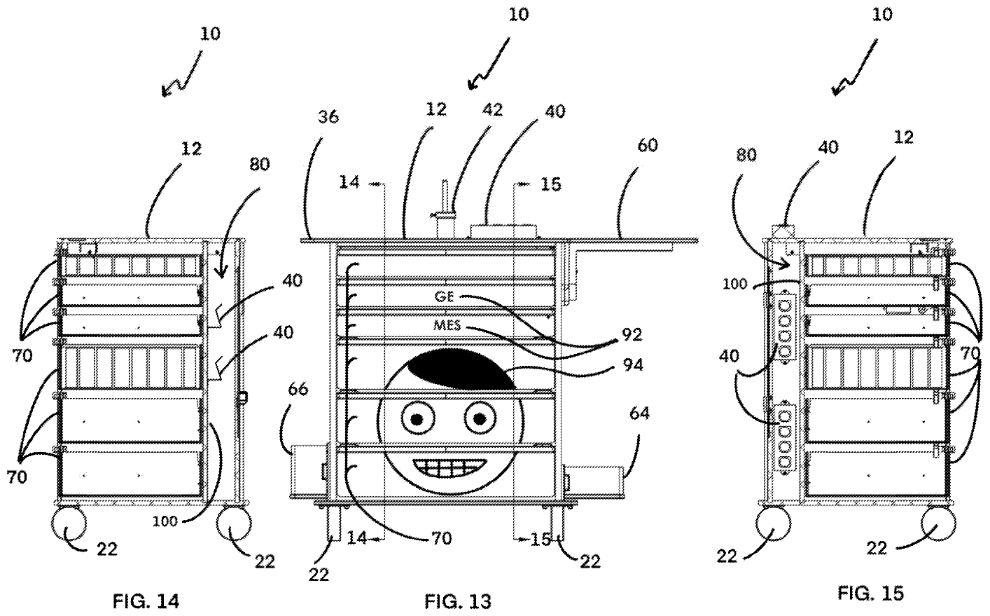

The back 20 of the cart assembly 10 includes a door 72 that opens to reveal a cord locker 80. The cord locker 80 contains one or more cable managers 82. An embodiment of a cable manager 82 is shown in FIGS. 9-13. The one or more cable managers 82 may include a mounting surface 83 defining mounting holes 84 used to affix the cable manager 82 to an interior wall 100 defining the back of the cord locker 80. The cable manager 82 may optionally be economically formed from a sheet of any bendable material, such as aluminum, or moldable/formable like plastic. The cable manager 82 shown in the figures includes a 90-degree bend 85 that forms a horizontal shelf 86, on which loops of cord may rest. Next, the cable manager 82 has an upward bend 87 to form a hook 88. The upward bend 87 is shown as forming an acute angle with the horizontal shelf 86 of approximately 73 degrees. Though this angle could obtuse or normal to the horizontal shelf 86, forming an acute angle allows room for a final, outward bend 89 to create an upper guide 90 that facilitates ease of use for one placing cord loops on the cable manager 82. It is further contemplated that the cable manager 82 could be configured in many different ways, such as straps or clips that would allow cables to be easily contained.

The cord locker 80, as seen in FIGS. 14-16, also includes one or more, in this embodiment two, additional power strips 40. Additional power strips 40 are provided due to the large number of electronics commonly used with biomedical carts. The cord locker 80 thus provides an ideal solution to providing power outlets and cord storage in an enclosed space that prevents the cords from interfering with moving and operating the cart assembly 10. As previously mentioned, the top 12 may include a power cord access hole 38. This power cord access hole 38 leads to the cord locker 80 such that the outlets on the power strips 40 may be easily accessed and allows the door 72 to remain closed during use. The cord locker 80 also provides some storage capabilities should this be needed.

The cart assembly 10 is supported by four casters 22. In at least one embodiment, the casters 22 are large, robust components (in this embodiment five inches in diameter) to allow smooth rolling over various surfaces. The casters may also be static displacing to protect electronic equipment carried by the cart assembly 10 from potentially adverse effects of static electricity. One or more of the four casters 22 may include a locking feature, as is known in the art. In at least one embodiment, the casters 22 not only have a large diameter, but also soft rubber contact surfaces as well along with high-quality bearings such that the cart meets the often-strict sound requirements found in hospitals.

In at least one embodiment, the cart assembly 10 is highly customizable. For example, scratch-resistant, panels 92, 94, 96 may be provided to cover many surfaces of the cart 10, including the drawers, the back, and the sides of the cart assembly 10. These panels are available in a variety of colors and are constructed from a material, such as aluminum, which is receptive to modern printing techniques, such as sublimation printing.

Sublimation printing is a printing technique in which a design is transferred from a transfer paper having a design printed thereon using special sublimation inks. In typical practice, the paper is placed on a receiving surface and heated until the ink enters a gaseous state and infiltrates the surface on a molecular level. Because the ink is transferred as a gas, and not as a film, the ink is not subjected to scratches, fading, peeling, or cracking. The resulting image is a vibrant, lasting high-resolution design. As such, using panels 92, 94, 96 upon various surfaces of the cart 10, provides designs and labels in which not only are the colors customizable, but branding and/or drawer identifiers may be provided, without the need for customer labeling devices, which can fade and peel over time.

In at least one embodiment, the panels 92, 94, 96 are laminate panels that are easily applied to one or more of the outside surfaces of the cart. These surfaces then become substrates for the printable panels and may be any or all of the vertical surfaces including the drawer fronts. The laminate panels are constructed of any material, such as aluminum, which accepts sublimation printing. These panels may be attached magnetically to the substrate surfaces, or there may be other attachment means provided such as upper and lower slots sized to allow the panels to be slid into place. Further, in certain embodiments, panels 92, 94, 96 are permanently attached to the corresponding surfaces of the cart assembly 10 using various attachment approaches, such as adhesives of locking connectors.

It is within the scope of the invention to take advantage of the versatility of these printable panels to allow the cart to be repurposed quickly and repeatedly, if needed, by swapping panels to convey different information, such as drawer contents, use status, warnings, colors, advertisements, and the like. It is also contemplated that the drawer panels present a one or more larger designs that occupy multiple drawers.

The figures show various examples of labels and designs that illustrate the versatility of the panels. For example, in FIG. 1, a large design 94 is shown that resembles a smiling face that occupies the fronts of three drawers. FIG. 2 shows a panel 96 that conveys a warning that electricity is present, and another panel 98 with a logo printed on it. FIG. 4 shows panels 92 being used to convey the contents of the drawers 70 on which they are placed.

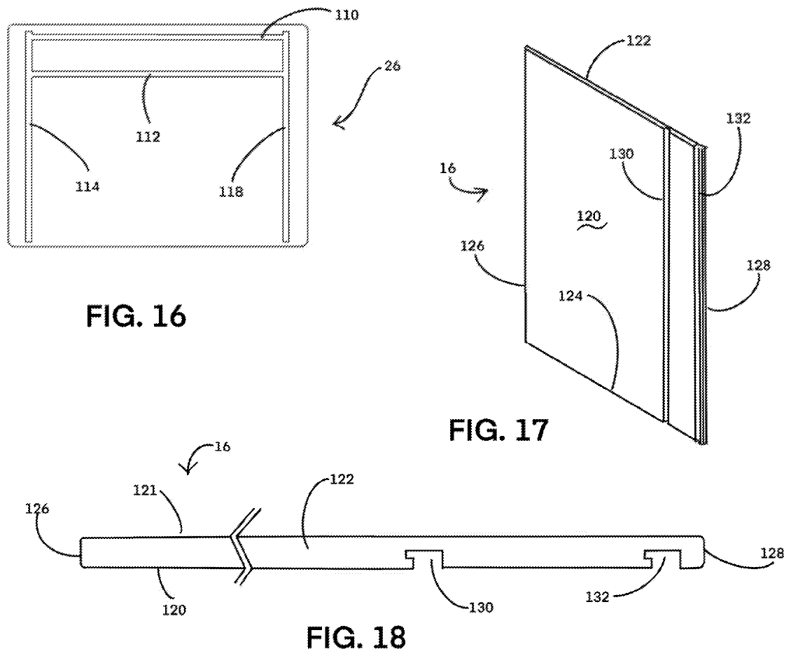

It is mentioned above that many facilities, such as hospitals, have noise limitations that must be met. In addition to using high-quality, large diameter casters 22, sound can be reduced through sturdy construction practices. For example, referring to FIGS. 16-20, it is shown that at least one embodiment of the cart assembly 10 utilizes interlocking panel construction to prevent rattling while the cart is being used or transported. For example, FIG. 16 shows a floor panel 26 having recessed floor slots 110, 112, 114 and 116. Floor slot 110 receives a bottom edge of the back 20. Floor slot 112 receives a bottom edge of the interior wall 100. Floor slot 114 receives a bottom edge of the left side 16 and floor slot 116 receives a bottom edge of the right side 18. These slots add rigidity to the overall construction of the cart 10 and serve to dampen vibrations to the walls received by the slots.

Additionally, FIG. 17 shows an embodiment of a side wall usable for either left side 16 or right side 18 (understanding that left side 16 and right side 18 are mirror images of each other, the side wall shown may be inverted to serve as either wall). For purposes of clarity, the side wall shown in FIG. 17 will be described as left side 16 since the orientation shown is correct for left side 16. The embodiment of left side 16 shown in FIG. 17 has an interior side 120, an exterior side 121 opposite the interior side (hidden in FIG. 17), a top edge 122, a bottom edge 124, a front edge 126, and a rear edge 128. Additionally, the interior side 120 has a mid-groove 130 and a rear groove 132. The mid-groove 130 and the rear groove 132 are shown in greater detail in FIG. 18, which is a top view of the left side 16.

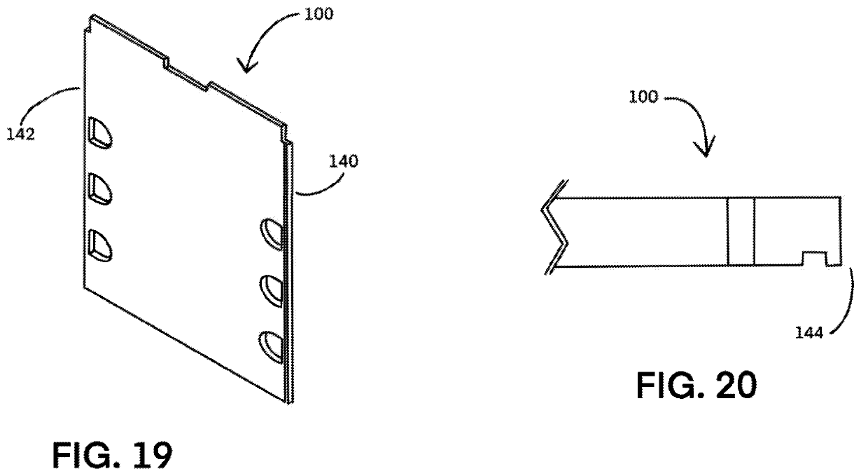

The grooves 130 and 132, in this embodiment, are identical except for their locations, in order to ease manufacturing. Each groove 130 and 132 have an “L” shape that receives a correspondingly shaped, interlocking tongue found on the edges of the walls received by the grooves 130 and 132, shown and described in FIGS. 19 and 20.

The mid-groove 130 is positioned to accept the interior wall 100, which is shown in FIG. 19. The interior wall 100 includes side edges 140 and 142 having tongues that are configured to mate with the mid-groove 130 of a corresponding side wall. An example of a tongue 144 is shown in FIG. 20. The tongue 144 has an “L” shape that slides into the “L” shaped groove 130 or 132. This configuration greatly reduces noise and provides the cart assembly 10 with a sturdy, high-quality construction.

FIGS. 21-25 depict embodiments by which more than one cart assembly may be connected together to form an extended work surface. FIG. 21 shows three cart assemblies 10, each including a folding table extension 60 located on its left side 16, and a one or more integrated handles 36 on the right side 18. Each folding table extension 60 is connected to the one or more integrated handles 36 of the adjacent cart assembly 10.

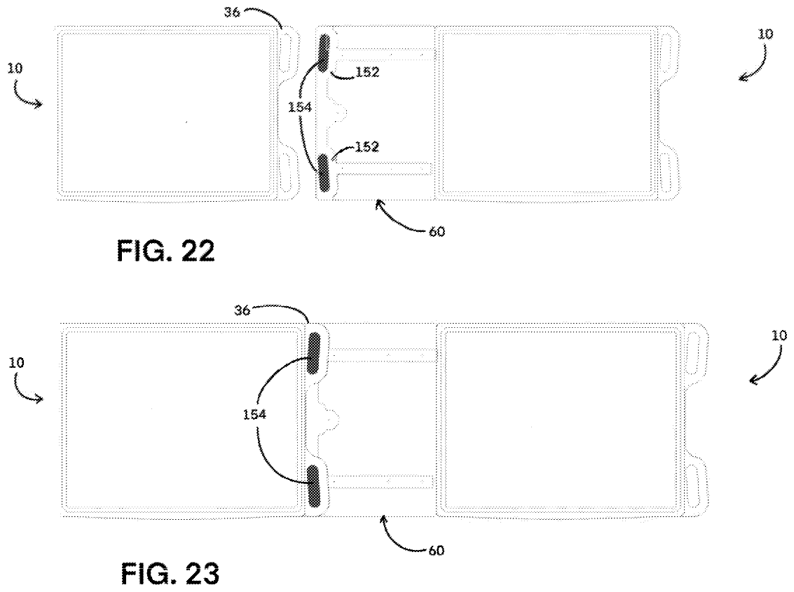

FIGS. 22-23 are bottom views that show the connection between a folding table extension 60 of one cart assembly 10 and the integrated handles 36 of an adjacent cart assembly 10. The folding table extension 60 has a bottom surface 150 that includes areas 152 where material has been removed. These areas 152 are shaped to form downward extending pegs 154, that are shaped to mate with the one or more integrated handles 36 of the adjacent cart assembly 10. FIG. 22 shows the two cart assemblies 10 in a disconnected state while FIG. 23 shows them in a connected state. Referring back to FIG. 21, the one or more integrated handles 36 extend below the flat work surface 32 by a depth that approximates the thickness of the areas 152 such that, when connected, a top surface 156 of the folding table extension 60 is relatively flush with the flat work surface 32.

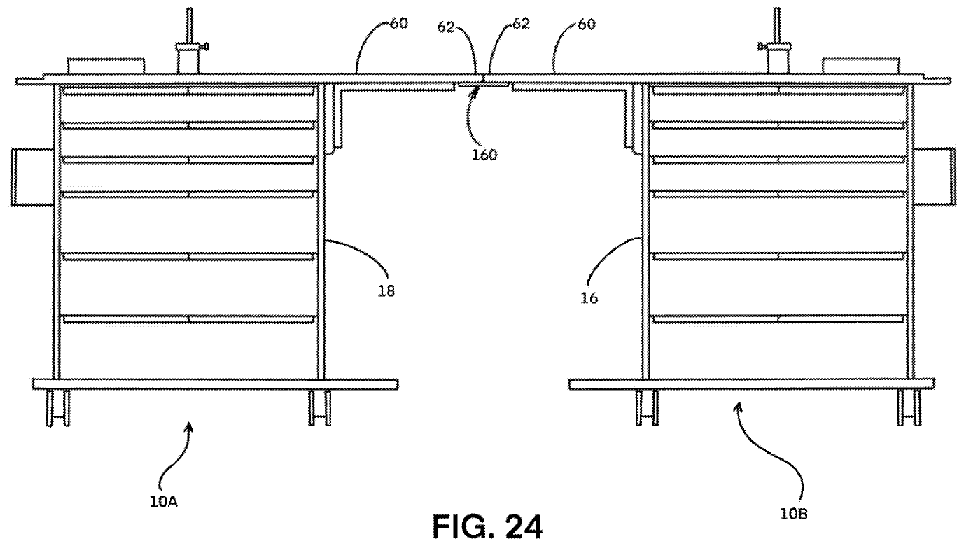

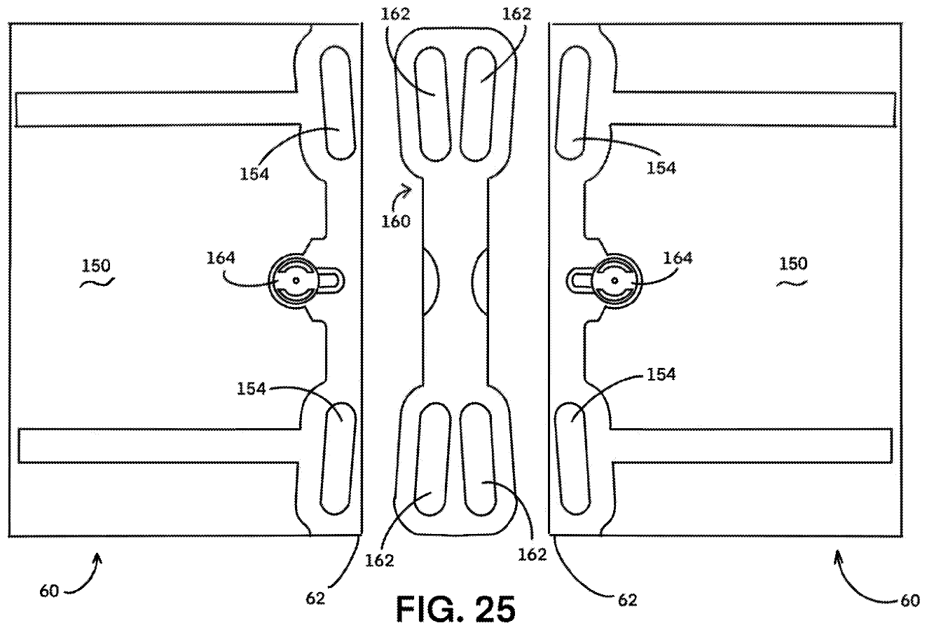

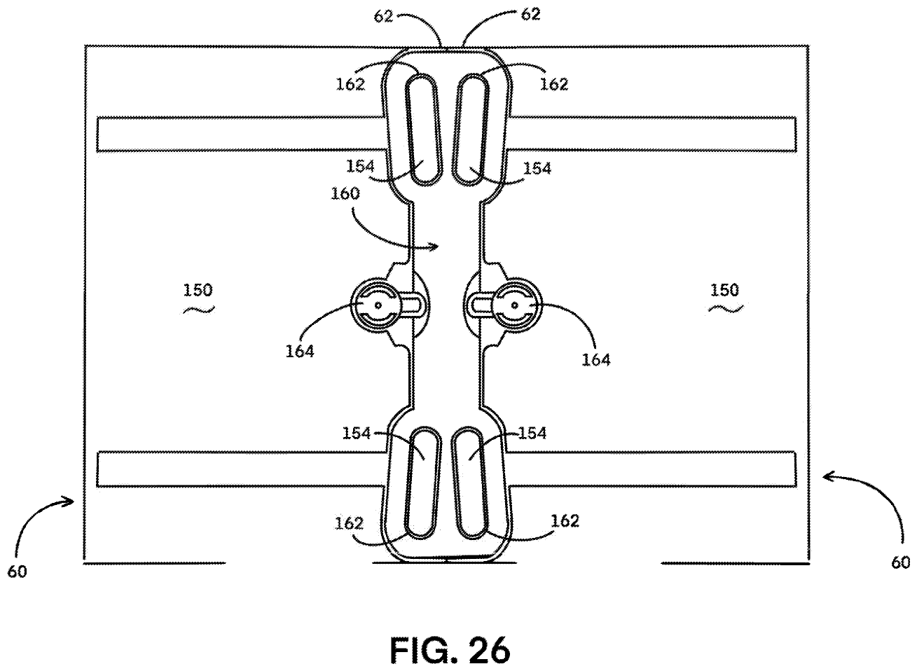

FIGS. 24-26 show an embodiment whereby a first cart assembly 10A has a folding table extension 60 on its right side 18 and second cart assembly 10B has a folding table extension 60 on its left side 16. The folding table extensions 60 are connected together at their distal ends 62 using an alignment bar 160 detailed in FIGS. 25 and 26.

The alignment bar 160 replicates the integrated handle 36 shape such it can be used with the existing folding table extension 60 design. More specifically, the alignment bar 160 takes a form that is similar to back-to-back handles in that there are four handle cut outs 162 that are spaced and oriented to mate with the downward extending pegs 154 of abutting folding table extensions 60. The alignment bar 160 is thus placed on the bottom surfaces 150 of the adjacent folding table extensions 60 in order to engage the downward extending pegs 154. In order to retain the alignment bar 160 in place, each folding table extension 60 has a rotating catch 164.

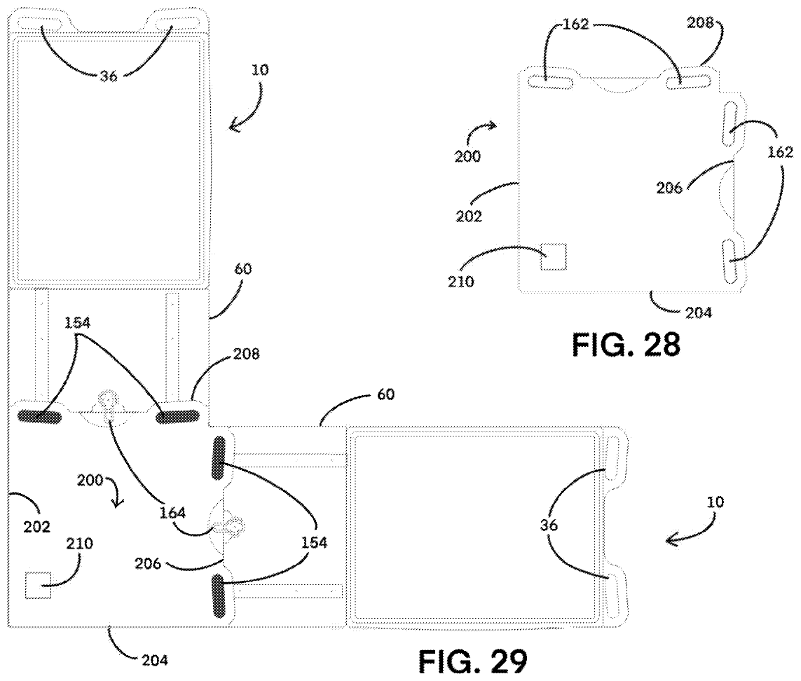

FIGS. 28 and 29 depict another connected configuration according to an embodiment of the invention using a corner table attachment 200. The corner table attachment 200 has four sides 202, 204, 206 and 208. Sides 202 and 204 are straight sides while sides 206 and 208 are configured similarly to the sides of the alignment bar 160 shown in FIGS. 25 and 26. Like the sides of the alignment bar 160, the sides 206 and 208 replicate the integrated handle 36 shape such the corner table attachment 200 can be used with the existing folding table extension 60 design. More specifically, each side 206 and 208 has two handle cut outs 162 that are spaced and oriented to mate with the downward extending pegs 154 of abutting folding table extensions 60. The corner table attachment 200 is thus placed on the bottom surfaces 150 of the adjacent folding table extensions 60 in order to engage the downward extending pegs 154. In order to retain the corner table attachment 200 in place, each folding table extension 60 has a rotating catch 164.

In order to add support to the corner table attachment 200, and increase the weight it can hold, a support leg 210 may be provided in one or more corners of the corner table attachment 200 and may be foldable, collapsible, telescoping, removable or any other configuration or construction for making the corner table attachment 200 easily storable when not in use.

Although the various embodiments have been described in in light of various configurations and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A cart assembly comprising:
a top, a front, a left side, a right side, and a back;
the top including a top panel that defines a work surface;
the front including a plurality of drawers;
at least one of the left side and the right side including a folding table extension;
at least one of the left side and the right side including one or more handles;
the back including a door that opens to provide access to a cord locker, the cord locker including:
at least one cable manager;
at least one power strip;
wherein the at least one power strip may be plugged into an outlet outside of the cart assembly while the door is closed and excess cord from the at least one power strip may be looped around the at least one cable manager;
wherein power from the at least one power strip is accessible through an opening in the top panel such that electronic equipment on or near the cart may be powered by the power strip while the door is closed;
a plurality of panels, each sized and shaped to be applied to one or more surfaces of the drawers, sides and back of the cart, the panels constructed of a material suitable to receive printed media.

2. The cart assembly of claim 1 wherein the top panel further defines at least one recessed tray.

3. The cart assembly of claim 1 wherein the top further includes an additional power strip.

4. The cart assembly of claim 1 wherein the top further includes a pole support attached to the top panel and usable to support a mounting pole extending upwardly from the top panel and constructed to provide an attachment point for accessories.

5. The cart assembly of claim 1 wherein at least one of the left side and the right side includes a basket.

6. The cart assembly of claim 1 wherein the at least one cable manager comprises a plurality of cable managers.

7. The cart assembly of claim 1 wherein the at least one power strip that the cord locker includes comprises a plurality of power strips.

8. The cart assembly of claim 1 wherein the folding table extension comprises an interlocking feature that allows a distal end of the folding table extension to connect with an adjacent cart assembly.

9. The cart assembly of claim 8 wherein the interlocking feature comprises pegs proximate the distal edge of the folding table extension that are configured to mate with the one or more handles of the adjacent cart.

10. The cart assembly of claim 8 wherein the interlocking feature comprises pegs proximate the distal end of the folding table extension that are configured to mate with an alignment bar having handle cut outs on two opposing sides such that the interlocking feature of one cart can be attached to one of the two opposing sides and the interlocking feature of an adjacent cart can be attached to the other of the two opposing sides.

11. The cart assembly of claim 8 wherein the interlocking feature comprises pegs proximate the distal end of the folding table extension that are configured to mate with a corner table attachment having handle cut outs on two adjacent sides such that the interlocking feature of a first cart can be attached to one of the two adjacent sides and the interlocking feature of a second cart can be attached to the other of the two adjacent sides, the two adjacent sides configured such that when the first cart, the second cart, and the corner table attachment are connected, the assembly fits in a corner of a room.

12. A cart system comprising:
a first cart and at least a second cart, each including:
a front with a plurality of drawers;
a left side, a right side, a folding table extension on one of the left side and the right side, and a top including a working surface;
one or more integrated handles on at least one of the left side and the right side, opposite the folding table extension
an interlocking feature on a distal edge of the folding table extension that allows the first cart to be joined with the second cart.

13. The cart system of claim 12 wherein the interlocking feature connects the table extension of the first cart with the one or more integrated handles of the second cart.

14. The cart system of claim 12 further comprising an alignment bar that connects the folding extension of the first cart to the folding table extension of the second cart.

15. The cart system of claim 12 further comprising a corner table attachment that connects the first cart at a right angle to the second cart.

16. The cart system of claim 15 wherein the corner table attachment includes a support leg.

17. The cart system of claim 15 wherein the corner table attachment has handle cut outs that are spaced and oriented to mate with the interlocking features of the first cart and the second cart.

18. The cart system of claim 12 wherein each of the first cart and the second cart includes at least one cable manager.

19. A modular cart system comprising a plurality of carts, each of the carts comprising:
a plurality of drawers;
at least one folding table extension;
a cord locker including a plurality of cable managers and at least one power strip;
a plurality of panels, each sized and shaped to be applied to one or more surfaces of the drawers, sides and back of the cart, the panels constructed of a material suitable to receive printed media;
wherein each of the plurality of carts is connectable to at least another cart of the plurality carts to create a top working surface that spans the connected carts.

20. The modular cart system of claim 19 wherein the top working surface includes the folding table extension of at least one cart.
